(19) United States
(12) Patent Application Publication
(10) Pub. No.: US 2012/0253882 A1
(43) Pub. Date: Oct. 4, 2012

(54) Identification of Instable Service Plan

(75) Inventors: Saravanan MOHAN, Chennai (IN); Sujit Kumar Reddy KAMIREDDY, Hyderabad (IN); Yeshwanth VIJAYAKUMAR, Chennai (IN)

(73) Assignee: Telefonaktiebolaget L M Ericsson (publ), Stockholm (SE)

(21) Appl. No.: 13/294,646

(22) Filed: Nov. 11, 2011

(30) Foreign Application Priority Data
Mar. 28, 2011 (IN) 858/DEL/2011

(51) Int. Cl. G06Q 10/06

(52) U.S. Cl. 705/7.28

(57) ABSTRACT

A method for identification of an instable network operator service (NOS) plan having one or more mobile users. Instable NOS plans are determined by first determining a heterogeneity constant for each of a plurality of NOS plans. Based at least in part on the constant, the NOS plans are classified among different categories, wherein at least one category identifies an instable NOS plan. For each of the mobile users subscribed to at least one of the instable NOS plan category, determining a best NOS plan from amongst the plurality of NOS plans and a sample network operator service plan based at least in part on a spending behavior of the respective ones of the mobile users. Identifying, the instable NOS plan from amongst the plurality of NOS plans in which maximum number of mobile users correspond to the sample NOS plan as the correspondingly determined best NOS plan.

### TECHNICAL FIELD

Implementations described herein relate to a system, a method, a service plan management apparatus and a computer program product for identification of an instable network operator service plan having one or more mobile users.

### BACKGROUND

In general, modern marketing strategies of an organization emphasize on understanding the product-wise behavior of the consumers towards service and products being marketed. Knowing the behavior of the consumers allows the organization to tune and use their marketing resources efficiently and reap fortunes. With specific reference to telecom operators, the only strategy, which gives sustainable advantage in the present competitive scenario, is to understand the consumers and serve them in a better and efficient way to increase their loyalty aspects with the telecom operator.

Nowadays, consumers are using different kinds of service or tariff plans provided by a telecom operator, of which they might not know whether they are using the best plan that actually serves their needs with optimal spending. If the consumers are not using the optimal plan, there is a high probability that such consumers might leave for another service plan of a competitor, i.e. such consumers might become potential so-called churners. Competitors generally target such customers to take them into their network by offering them new and attractive service plans. When a competitor launches a new service plan into the market, immediately other telecom operators need to identify the group (targeted) of customers, who will be largely benefited by the competitors newly launched plan so that measures can be taken to retain their own customers in the network.

One of the existing call tariff determination methods in mobile telecommunication networks has a provision to access network in respect of a roaming mobile telephone subscriber. Another related study describes method and system for optimizing the performance of a network. The above solutions do not deal with tariff plan optimization in telecom networks but merely relates to optimization of network resources.

In addition, there are certain web-based solutions such as websites available nowadays which addresses the concerns of the subscribers in choosing the best service plans available in the market irrespective of the network providers. Such web-based solutions request the user to input his/her spending details on different features over a period of time and outputs the best suitable service plan of all the available service plans in the market. The website has some pre-determined information on the rates of different service plans in the database and as soon as the user enters his approximate spending behavior, the associated web server processes the amount of money the customer might spend on each of the available service plans and outputs the service plan that makes the customer spend the least. However, understanding the real patterns from usage and spend behavior of subscribers for a longer period may be an important measure for prediction of real problems with their present plan.

In addition, there is a need of specific method to understand the real scenario of the telecom operator's present service plans, which will improve and satisfy their potential customers keeping in mind the benefit of the operator.

Hence there is a need to predict the customer behavior towards different plans, analyze, and determine the best of the currently existing plans for each customer or group of customers.

Moreover, the analysis in the existing current systems is often done with the pre-defined consumer groups in mind rather identifying a targeted customer group. Example of pre-defined groups may be consumers of a particular service class. There exists no process or system, which identifies the group of customers who will be affected by a newly launched service plan (e.g. from a competitor). In addition, there exists no process to combine the consumer capability or preference or behavioral information with usage data to predict the customer behavior with respect to another service plan (which the customer is not using or not even related to in any way).

Hence, there is a well-felt need for overcoming at least the above-mentioned shortcomings in the art and for mitigating the above noted impact on current consumer base due to dis-satisfied consumers resulting from sub-optimal or non-optimal tariff plans.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

It is an object of the invention to identify an instable network operator service plan having one or more mobile users.

Embodiments of the invention discloses a method for identifying an instable network operator service plan from a plurality of network operator service plans, each of the plurality of network operator service plans having one or more mobile users. The method being performed by a computer and comprises the steps of determining a heterogeneity constant for each of the plurality of network operator service plans. The heterogeneity constant is representative of instability of each of the plurality of network operator service plans.

The method further comprises of classifying the network operator service plans among different categories of network operator service plans based at least in part on the heterogeneity constant, wherein at least one category identifies an instable network operator service plan. According to an embodiment the classifying may comprise defining one or more threshold values for the heterogeneity constant. According to yet another embodiment the classifying comprises comparing the determined heterogeneity constant with the one or more threshold values.

The method further comprises of determining for each of the mobile users subscribed to at least one of the instable network operator service plan category, a best network operator service plan from amongst the plurality of network operator service plans and a sample network operator service plan based at least in part on a spending behavior of the respective ones of the mobile users. According to an embodiment determining the best network operator service plan comprises obtaining spending behavior of each of the mobile users subscribed to at least one of the instable network operator service plan category respectively. According to yet another embodiment determining the best network operator service plan may comprise associating the mobile users subscribed to at least one of the instable network operator service plan category to every other network operator service plan in the plurality of network operator service plans keeping the respective spending behavior constant. According to yet another embodiment determining the best network operator service plan may comprise calculating the spending in each of the network operator service plan based on the association of the mobile users subscribed to al least one of the instable network operator service plan category. According to yet another embodiment determining the best network operator service plan may comprise determining a payoff matrix between the mobile users and a network operator when the best network operator service plan corresponds to one of the plurality of network operator service plans offered by the network operator and the sample network operator service plan. According to yet another embodiment the best network operator service plan corresponds to at least spending by the mobile users. According to yet another embodiment the best network operator service plan corresponds to at least spending by the mobile users and a maximum revenue for a network operator with respect to a given network operator service plan.

The method further comprises of identifying the instable network operator service plan from amongst the plurality of network operator service plans in which maximum number of mobile users correspond to the sample network operator service plan as the correspondingly determined best network operator service plan. According to an embodiment the method may further comprise stabilizing the instable network operator service plan based at least in part on the identifying. According to yet another embodiment the stabilizing may comprise modifying tariff rates associated with the instable network operator service plan. According to yet another embodiment the stabilizing may comprise modifying tariff rates associated with one or more of the plurality of network operator service plans other than the instable network operator service plan. According to yet another embodiment the stabilizing may comprise proposing a new network operator service plan substantially similar to the sample network operator service plan. According to yet another embodiment the stabilizing may comprise computing one or more service parameters of the instable network operator service plan, the sample network operator service plan, and one or more of the plurality of network operator service plans. According to yet another embodiment the stabilizing may comprise comparing the one or more service parameters of the instable network operator service plan with the sample network operator service plan and/or the one or more of the plurality of network operator service plans. According to another embodiment the one or more service parameters corresponds to one or more of revenue, tendency, time stability, stability metric, and age stability associated with the instable network operator service plan, the sample network operator service plan, and one or more of the plurality of network operator service plans.

According to an embodiment identifying the instable network operator service plan further may comprise calculating a net heterogeneity constant of the plurality of network operator service plans prior to and subsequent to the associating of the plurality of mobile users.

Embodiments of the invention discloses a system for determining an instable network operator service plan from amongst a plurality of network operator service plans with respect to a sample service plan. The system comprises of a charging module configured to provide mobile usage data associated with a plurality of mobile users, wherein each of the plurality of mobile users subscribed to one of the plurality of network operator service plans.

The system further comprises of a service plan management module configured to compute a heterogeneity constant for each of the plurality of network operator service plans based on the mobile usage data and determine the instable network operator service plan based at least in part on the computed heterogeneity constant. According to an embodiment the service plan management module may further configured to, classify the network operator service plans among different categories of network operator service plans, wherein at least one category identifies an instable network operator service plan based at least in part on the heterogeneity constant. According to yet another embodiment the service plan management module may further configured for each of the mobile users subscribed to at least one of the instable network operator service plan category, determine a best network operator service plan from amongst the plurality of network operator service plans and a sample network operator service plan based at least in part on the spending behavior of the mobile users. According to yet another embodiment the service plan management module may further configured to stabilize the instable network operator service plan. According to yet another embodiment the service plan management module may further configured to compute a net heterogeneity constant of the plurality of network operator service plans, the net heterogeneity constant being indicative of the stability of the system in relation to the association of the plurality of mobile users and corresponding network operator service plans.

The system may further comprise of a visualization module configured to generate visual representation and statistical reports representing instability of the plurality of network operator service plans.

According to an embodiment the instable network operator service plan corresponds to one of the network operator service plan in which maximum number of mobile users corresponds to the sample network operator service plan as the determined best network operator service plan.

Embodiments of the invention discloses a service plan management apparatus for determining one or more instable network operator service plans from amongst a plurality of network operator service plans with respect to a sample network operator service plan. The service plan management apparatus comprises of a data collection module configured to collect mobile user data from one or more data sources. The mobile user data is associated with a plurality of mobile users subscribed to the plurality of network operator service plans. According to an embodiment one or more data sources may comprise one or more of Call Data Record (CDR), Charging Reporting System (CRS), Service Data Point (SDP), Interactive Voice Response (IVR), Voucher data, Device data, Customer Care data, Packet data, etc.

The service plan management apparatus may further comprises of a knowledge exploration and discovery module configured to selectively process the mobile user data and determine heterogeneity constant for the plurality of network operator service plans based on the mobile user data. The knowledge exploration and discovery module may further configured to determine the one or more instable network operator service plans based at least in part on the heterogeneity constants.

The service plan management apparatus may further comprises of a visualization module configured to present statistical graphs, reports, graphical representations based on instability of network operator service plans, and assist experts in modifying one or more rules corresponding to data collection, knowledge exploration, and discovery respectively.

The service plan management apparatus may further comprise of a service delivery application program interface (API) module configured to provide a subscription to the service plan management apparatus.

Embodiments of the invention disclose a computer program product. The computer program product comprises of a computer readable code means on which a computer program is stored and where the computer program when executed on a service plan management apparatus causes the computing based apparatus to access one or more data sources and obtain mobile usage data of all the mobile users subscribed to their respective network operator service plans. The computer programs further causes the computing based apparatus to compute a heterogeneity constant for each of the plurality of network operator service plans and a net heterogeneity constant for the plurality of network operator service plans based on the mobile usage data. The computer programs further causes the computing based apparatus to identify an instable network operator service plan based at least in part on the heterogeneity constant and spending habit of the plurality of mobile users and provide selectable options to stabilize the instable network operator service plan.

### BRIEF DESCRIPTION OF THE DRAWINGS

To further clarify the above and other advantages and features of the invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings in which:

FIG. 1 illustrates an exemplary system for determining an instable network operator service plan in accordance with an embodiment of the invention;

FIG. 2 illustrates an exemplary computing based service plan management apparatus for determining one or more instable network operator service plans in a mobile communication network, in accordance with another embodiment of the invention;

FIG. 3 illustrates a multi-tier service plan management apparatus with various layers in accordance with an embodiment of the invention;

FIG. 4 illustrates a method for identifying an instable service plan from a plurality of service plans in accordance with an embodiment of the invention;

FIG. 5 illustrates an exemplary method for determining tariff rates of a new service plan in accordance with an embodiment of the invention; and

FIG. 6 illustrates a computer program product in accordance with an embodiment of the invention.

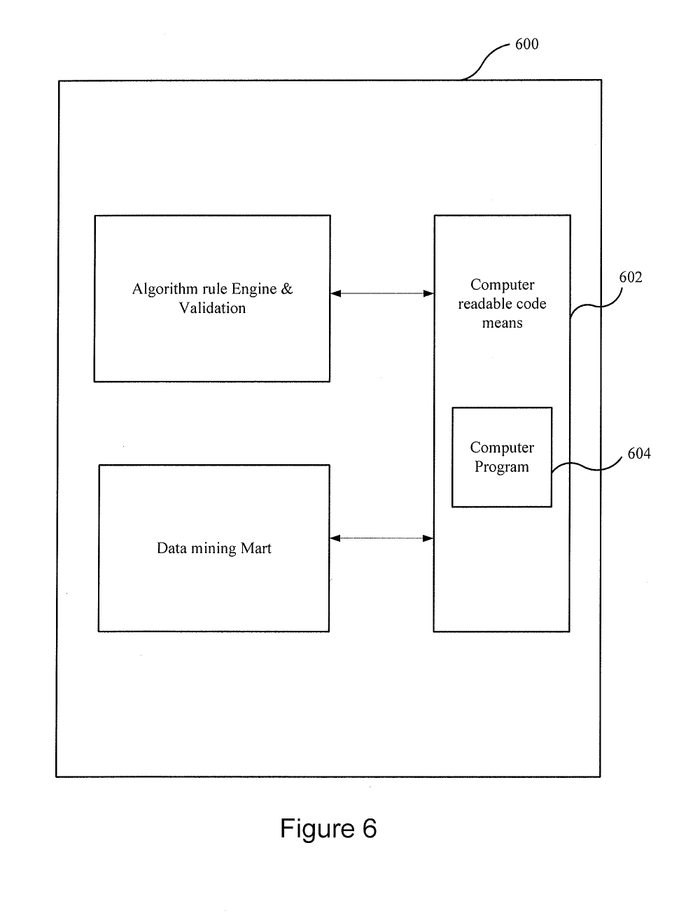

### DETAILED DESCRIPTION

A system, a method, a service plan management apparatus and a computer program product for determining an instable network operator service plan from amongst a plurality of network operator service plans in a mobile communication network are disclosed. The disclosed system, method, service plan management apparatus and computer program product also prevents an outflow of a plurality of mobile users from at least one network operator service plan to a sample network operator service plan.

In accordance with an aspect of the invention, the system and method facilitate in aggregating the details of: mobile users, one or more network operator service plans, and the behavior of the mobile users towards the network operator service plans. Based on such aggregated information, a network operator may identify a group of mobile users who have a high probability of churning out to a service plan from a competitor. Thus, the network operator may give special attention to such targeted mobile users rather than the entire customer base of the mobile users. The targeted attention enables efficient usage of the network operator's resources. Further, to retain the targeted mobile users, the network operator may optimize the network operator service plans or propose new service plans, based on market forces.

The disclosed invention defines a new metric (measure), which indicates instability of a service plan with respect to a sample service plan (for e.g. a newly launched plan by the competitor). Using the metric, the disclosed system precisely determines the instability of all existing service plans for all mobile users in the mobile communication network. In accordance with an embodiment of the invention, a specific payoff can be determined if the mobile user are put in another plan in contrast to their existing plan. The payoff is determined keeping in mind the network operator's revenue enabling mutual benefit for both the mobile user and the network operator. The system and method enable a user to understand the features of instable service plans by calculating specific statistical measures referred to as “service parameters”. Based on the values of service parameters, the instable network operator service plans may be modified or a new network operator service plan can be introduced to prevent the mobile users subscribed to the instable network operator service plan churn out to the sample service plan.

### Exemplary System

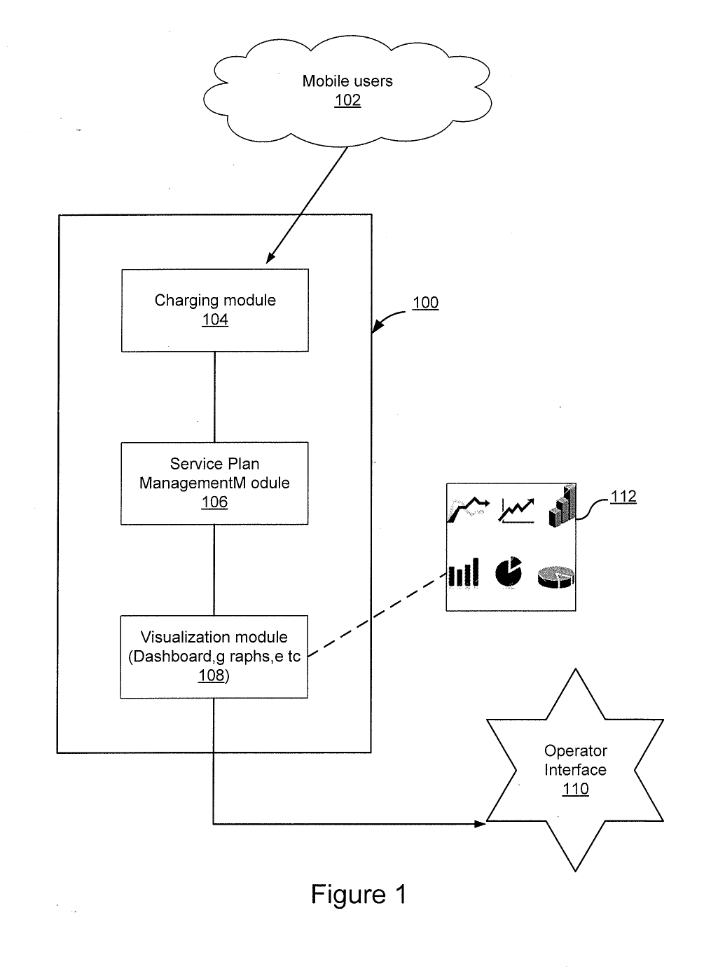

Referring to FIG. 1, an exemplary system 100 is illustrated, for determining an instable network operator service plan from amongst a plurality of network operator service plans in a mobile communication network. The system 100 is adapted to process mobile usage data associated with a plurality of mobile users 102, which forms a consumer base for the mobile communication network. The mobile users 102 correspond to subscribers of a plurality of service plans offered by a network operator. In order to retain the existing mobile users and to increase the consumer base by attracting more mobile users, the network operator launches a plurality of network operator service plans to suit different requirements of the mobile users 102. A network operator service plan launched by the network operator can be considered having a set of features like local call rate, local SMS rate, National call rate, GPRS usage rate, download rate, etc. Each of the mobile users 102 subscribes to at least one of the network operator service plans as per the individual's need.

A typical mobile communication network in an area may comprise multiple network operators having respective consumer bases. Each such network operator, with an aim to maximize consumer base, launches new network operator service plans that are targeted at a group of mobile users subscribed to network operator service plans of other network operators. For purposes of the ongoing description, such a plan launched by a competing network operator to attract mobile users subscribed to a given network operator has been referred to as a “sample service plan”. However, it may be noted that for purposes of determination of instability of any service plan in various embodiments, any existing service plan (whether network operator's or competitor's) may be considered as a sample service plan.

The system 100 comprises a charging module 104 configured to provide mobile usage data associated with the mobile users 102 subscribed to a plurality of network operator service plans. Examples of the mobile usage data comprises, but are not limited to, the type of use, duration of use, location of mobile usage, number of calls made, time (of day) of use, and the like. Typically, every network operator employs one or more subsystems, such as, a charging subsystem that maintains an account of usage of the mobile users 102 for charging purposes. In addition to the abovementioned mobile usage data, the charging module 104 may store such other information as may be required for profiling of the mobile users 102. For example, such other information may comprise salary details, spending patterns, details of currently subscribed tariff plan, age group of the user, occupation, and the like.

### Determination of Heterogeneity Constant (HC):

The system 100 further comprises a service plan management module 106 configured to utilize the mobile usage data provided by the charging module 104 and compute a heterogeneity constant for each of the plurality of network operator service plans. In the context of the present disclosure, Heterogeneity Constant (HC) is defined as a metric/measure to quantify the level of satisfaction/dissatisfaction of the mobile users 102 in a given network operator service plan (of the network operator or otherwise).

In accordance with an embodiment of the invention, the Heterogeneity Constant (HC) is calculated by using the below mentioned equation:

$$Heterogeneity Constant = \frac{( u / v ) * {i}^{Σ} {P}_{i}}{n}$$

where,

i=1, 2, 3, . . . n

Pᵢ is a parameter value of iₜₕ mobile user in a service plan

n is the total number of mobile users subscribed to the service plan

u is the number of mobile users with Pᵢ value>=Upper_threshold value

v is the number of mobile users with Pᵢ value<=Lower_threshold value

### Calculation of Pᵢ:

If service plan ‘x’ corresponds to the best service plan for the i^{th} customer or mobile user, who is currently subscribed to the service plan ‘x’ itself, then a SPM (service plan management) module 106 finds service plan ‘y’ which is the second best service plan for the i^{th} customer. Pᵢ can be calculated as follows:

Pᵢ=Total virtual spending w.r.t service plan ‘y’—Total spending w.r.t service plan ‘x’,

where virtual spending of a customer w.r.t a given network operator service plan is the total amount the customer might spend w.r.t the given network operator service plan if he had subscribed to the given network operator service plan with the same spending behavior (as in the currently subscribed service plan). The virtual spending can be calculated by a vector product of tariff rates of the given network operator service plan (e.g. Rs. 5 per local SMS, Rs.3 per local etc) and the spending behavior of the customer (e.g. 20 local calls, 20 SMS, 5 international calls, etc.).

On the other hand, if service plan ‘z’ corresponds to the best plan for the i^{th} customer, who is currently subscribed to service plan ‘x’, then:

Pᵢ=Total virtual spending w.r.t service plan ‘z’—Total spending w.r.t service plan ‘x’

In order to calculate the heterogeneity constant, the mobile users 102 are divided into “N” clusters, where N represents the total number of network operator service plans provided by the network operator. Each cluster comprises the mobile users who are currently subscribed to the corresponding network operator service plan. Thereafter, the heterogeneity constant for each cluster is evaluated by using the equation mentioned above.

In accordance with an embodiment of the invention, in addition to the evaluation of the heterogeneity constant as mentioned above, the SPM module 106 further computes a Net Heterogeneity Constant (NHC) of the network operator service plans. The NHC indicates the stability of the system 100 in relation to the association of the mobile users and the corresponding network operator service plans. The net heterogeneity constant can be calculated by using the below mentioned equation:

$$Net Heterogeneity Constant ( NHC ) = \frac{ΣΣ {n}_{i} * {HC}_{ji}}{N} ( 1 \text{<=} i \text{<=} N ) ( 1 \text{<=} j \text{<=} {n}_{i} )$$

Where,
nᵢ is the number of customers in the cluster i
HCⱼᵢ is the Heterogeneity constant of the cluster i
N is the total number of mobile users in all the clusters

An increase in the value of NHC represents an increase in instability of the system (service plan-mobile user association) and a decrease in the value of NHC represents a decrease in stability of the system (service plan-mobile user association). For example, when a group of mobile users correspond to a best network operator service plan different from the existing network operator service plan, then for calculating NHC, the mobile users are associated with the respective best network operator service plans as if they were subscribed to the best service plan. The NHC values are computed before and after such an association. An increase in the value of NHC after association denotes an overall increase in instability as compared to pre-association phase.

In accordance with an embodiment of the invention, the SPM module 106 compares the determined HCs for each category with one or more threshold values. One or more threshold values can be defined by the network operator based on one or more factors such as lifetime value, network usage details, etc.

In accordance with yet another embodiment of the invention, the mobile user may be registered to use the services of a network and have association with a network operator service plan; the details of this association may be referred as network usage details. These details may also comprise the use of services by the mobile user such as tariff plan details, billing details, offers availed, etc.

In accordance with yet another embodiment of the invention, the lifetime value of the mobile user denotes the total usage of mobile services by the mobile user from the date of association of the mobile user with the current network operator service plan.

In accordance with yet another embodiment of the invention, the spending behavior is a pattern of usage of mobile services by a mobile user over a period of time. For example, a mobile user uses 700 voice call minutes, 20 sms and 100 mb of wap services every month, therefore the spending of the mobile user is more on voice calls. Hence, the mobile user would prefer a network operator service plan that attains to his need of voice calling and provides the mobile user with competitive tariff rates.

According to yet another embodiment of the invention, the network operator service plans may be classified into different categories of network operator service plans. The categories may be based on the grouping of network operator service plans with similar heterogeneity constant and/or a comparison of the HCs and one or more threshold values.

According to yet another embodiment of the invention, the categories may be divided into at least a stable and an instable category of network operator service plans. The stable category may corresponds to highly satisfying network operator service plans and the instable category may further have sub categories such as moderately satisfying network operator service plans and the least satisfying network operator service plans.

According to an exemplary embodiment of the invention, the categories of network operator service plans offered by the network operator may be classified as first category service plans, second category service plans, and third category service plans. The first category service plans correspond to highly satisfying network operator service plans, second category service plans correspond to moderately satisfying network operator service plans, and the third category service plans correspond to least satisfying network operator service plans. A high value of HC indicates at least satisfying network operator service plan and a low value of HC indicates a highly satisfying network operator service plan. In order to reduce storage requirements and processing power mandates, further analysis may be restricted to the network operator service plans belonging to second and third categories respectively. Again, the analysis can be restricted to network operator service plans with higher number of mobile users as compared to the rest of network operator service plans. In an alternative embodiment, one or more network operator service plans classified as second category and third category service plans can be considered for further analysis.

### Best Service Plan Determination:

For each of the mobile users 102 that are subscribed to the considered network operator service plans, the SPM module 106 determines a best/most suitable network operator service plan for a mobile user from amongst the network operator service plans and the sample network operator service plan (e.g. a new plan launched by a competitor) based at least in part on the spending behavior of the mobile users 102. Other criteria/parameters may be the tariff rates of the existing network operator service plan, average usage of the mobile user, etc. For example, for each of the mobile users subscribed to moderately satisfying and least satisfying network operator service plans, the SPM module 106 calculates the spending of each mobile user against each of the network operator's other service plans the sample network operator service plans by keeping the spending behavior constant. The spending of the mobile user may be calculated by a vector product of tariff rates of a given network operator service plan (e.g. Rs. 5 per local SMS, Rs.3 per local etc) and the spending behavior of the mobile user (e.g. 20 local calls, 20 SMS, 5 international calls, etc.). In an exemplary embodiment, the network operator service plan for which a given mobile user spends the least, with constant spending behavior, across all other network operator service plans (including sample service plan) is designated as the ‘best network operator service plan’ for the given mobile user.

According to an aspect of the invention, the SPM module 106 matches a constant containing the spending behavior and the tariff rates of the mobile user in a current network operator service plan against the other available network operator service plans and the competitors network operator service plan. Further, the SPM module 106 calculates the spending of the mobile user in each of the network operator service plans and the competitors' network operator service plan on the basis of the average usage by the mobile user and tariff rates of the existing network operator service plan. Further, the SPM module 106 computes the most suitable/cheaper network operator service plan available for the mobile user by selecting a best network operator service plan that best suits the mobile users requirements and spending behavior.

According to yet another embodiment, the best network operator service plan corresponds to least spending by the mobile users. According to yet another embodiment, the best network operator service plan corresponds to a network operator service plan that may generate maximum revenue for the network operator. The network operator may generate maximum revenue as they are providing the best service plan to the plurality of mobile users, and with the influx of more unsatisfied mobile users the network operator may maximize their profits.

It may however be noted that there may be cases where, for a given mobile user, the best network operator service plan corresponds to one of the network operator's own service plan. Since, in such a case, the mobile user has low probability of churning out or subscribing to the competitor network operator service plan, such mobile users are ignored for the purposes of determining the instable network operator service plan. In all cases, the best network operator service plan may be considered as the most optimum and cheaper network operator service plan for a given mobile user. In other words, the mobile user 102 may ideally discontinue their current network operator service plan and subscribe to the best network operator service plan.

According to an aspect, the network operator service plan that maintains the usage of the mobile services of the mobile user constant and provides these services at a cheaper tariff rate is the best network operator service plan for the mobile user. For example, a mobile user that mainly uses the calling facility, the best service plan will be a network operator service plan that provides the mobile user with the same usage of calling minutes at a cheaper cost than their original network operator service plan, although the best service plan, selected by said mobile user, may have higher charges for other services such as text messaging etc. According to another example, a mobile user that mainly uses the value added services such as data communication services, internet, messenger services, etc, the best service plan will be a network operator service plan that provides the mobile user with the same usage of data services at a cheaper cost than their original network operator service plan.

In accordance with an alternative embodiment of the invention, the best network operator service plan may correspond to the most optimum network operator service plan for a given mobile user and the network operator. In such an embodiment, the determination of best network operator service plan involves determining a payoff matrix between the existing network operator service plan of the mobile users and the best network operator service plan, wherein the best network operator service plan corresponds to one of the plurality of network operator service plans and the sample network operator service plan.

According to yet another embodiment, determining the best network operator service plan comprises of obtaining spending behavior of each of the mobile users subscribed to at least one of the instable network operator service plan category.

In accordance with yet another embodiment, the SPM module 106 implements a game theoretic solution to determine the best network operator service plan with respect to both the network operator and the mobile user. Accordingly, a payoff matrix is created considering three players: network operator, competitor of the network operator and mobile user. The payoff for the mobile user may correspond to the percentage increase of savings for the mobile user by changing from a current network operator service plan to a sample network operator service plan. On the other hand, the payoff for the network operator may correspond to the average percentage increase/decrease of revenue per mobile user by changing from the current network operator service plan to the sample service plan. In an exemplary embodiment of the invention, the payoff for the competitor service plan would be proportional to the matrix element of the closest matching plan of the network operator. A pure strategy provides a complete definition of how a player will play a game. In the ongoing context, the pure strategies are the network operator service plans on offer in the network. A mixed strategy on the other hand corresponds to an assignment of a probability to each pure strategy. This allows a player (e.g. mobile user) to randomly select a pure strategy. Mixed strategies may be considered more applicable to real life situations, such as the present context, because human behavior (behavior of mobile user) by nature is unpredictable. The SPM module 106 models the probabilities as a function of various player related factors in order to implement the most suitable approach.

### Probability Calculations

1. Mobile User:

Probability of a mobile user liking a network operator service plan can be defined as a function of: duration of usage of the plan, maximum stay rate of the mobile user in the given plan, and total number of service plans. A uniform distribution is preferable but if a mobile user is already attached to a given service plan, it indicates that the mobile user has an affinity towards the network operator service plan. Hence, probability for choosing that network operator service plan by the mobile user would be a factor of usage in that network operator service plan and is computed as below:

P(mobile user choosing a given service plan)=P(mobile user chooses the given service plan and likes it)=P(to choose plan)*(duration of stay in the given service plan/maximum duration of stay for the given service plan)

Therefore, P (mobile user likes given service plan)=duration of stay in the given service plan/maximum duration of stay for the given network operator service plan.

2. Operator:

A probability of an operator preferring a network operator service plan for the mobile user can be defined as a function of the Heterogeneity Constant of both the current service and the proposed service plan and the Net Heterogeneity Constants (NHC) respectively. The proposed network operator service plan can correspond to network operator service plan or the sample service plan (e.g. competitor service plan).

P(operator preferring a given service plan)=(HC(current)−HC(proposed))/NHC if numerator indicates a step towards stability.

Payoffs:
1. Subscriber Payoff: The payoff will be in terms of percentage increase of revenue for subscriber by changing from the current network operator service plan to the proposed network operator service plan.
2. Operator Payoff: The payoff for the operator will be in terms of average percentage increase/decrease of revenue per subscriber by changing from the current plan to the proposed. Therefore, overall payoff for

Player=Probability*Individual Payoff

A mixed Nash equilibrium state for the current game is obtained thereby obtaining a state where “neither side (player) gains by deviating from their respective equilibrium strategies”. Such a mixed Nash equilibrium state gives the unique opportunity of proposing a new network operator service plan to the mobile user that has mutual benefits for both the network operator and mobile user whereas proposing other network operator service plans would deal with optimizing the plan benefits for the customer alone.

### Nash Equilibrium in a Payoff Matrix:

The SPM module 106 identifies Nash Equilibrium on the payoff matrix thus created. To this end, the SPM module 106 applies the rule that if the first payoff number, in a duplet of a cell of the payoff matrix, is the maximum of the column and if the second number in the duplet in the cell is the maximum of the row—then the cell represents Nash equilibrium.

An example 3×3 payoff matrix is illustrated in Table 1 below:

TABLE 1

| | Proposed | Proposed | Proposed |
|---|---|---|---|
| | Service Plan A | Service Plan B | Service Plan C |
| Current | 0, 0 | 25, 40 | 5, 10 |
| Service Plan A | | | |
| Current | 40, 25 | 0, 0 | 5, 15 |
| Service Plan B | | | |
| Current | 10, 5 | 15, 5 | 10, 10 |
| Service Plan C | | | |

Applying the rule as above, the Nash Equilibrium cells are (B, A), (A, B), and (C, C). Now, for cell (B, A) 40 is the maximum of the first column and 25 is the maximum of the second row. For (A, B) 25 is the maximum of the second column and 40 is the maximum of the first row. For other cells, either one or both of the duplet members are not the maximum of the corresponding rows and columns. It may be appreciated that various well known methods can be implemented to determine the best network operator service plan that is mutually beneficial for the mobile user and the network operator.

### Determination of Instable Service Plan:

In a successive progression, the SPM module 106 determines the instable network operator service plan out of the plurality of network operator service plans based on the determination of the best service plans. In an embodiment, the instable network operator service plan corresponds to one of the network operator service plan from which the maximum number of mobile users corresponds to the sample service plan as the determined best service plan. It may be noted that for many mobile users, the best service plan may correspond to yet another network operator service plan. Since, the possibility of such mobile users to churn out (move to the competitor service plan) is not high; such mobile users can be safely ignored for the purpose of determination of instable network operator service plan in the ongoing context. Hence, instable network operator service plan corresponds to that network operator service plan from which maximum number of mobile user would find the sample service plan (e.g. competitor service plan) as the best service plan. In an embodiment, the SPM module 106 may consider one or more network operator service plans as instable network operator service plan for the purpose of the ongoing description.

### Stabilizing Instable Service Plan:

Subsequently, the SPM module 106 may take a corrective action to prevent an outflow of the mobile users from the instable network operator service plan to the sample service plan. This can be achieved by stabilizing the instable network operator service plan. In an embodiment, the SPM module 106 may stabilize the instable network operator service plan by modifying the tariff rates associated with the instable network operator service plan. In another embodiment, the SPM module 106 may stabilize the instable network operator service plan by modifying the tariff rates associated with the network operator service plans other than the instable network operator service plan. In yet another embodiment, the SPM module 106 may stabilize the instable service plan by launching a new network operator service plan substantially similar to the sample service plan.

In order to stabilize the instable network operator service plan, the SPM module 106 analyzes the features of the instable network operator service plan by calculating specific statistical measures associated with the plurality of the network operator service plans and the sample service plan. The effect of the sample service plan in the market can be measured by defining one or more service parameters which specify different behaviours of a given network operator service plan. In an embodiment, the one or more service parameters comprise revenue, tendency, time stability, stability, and age stability of the plan. The one or more service parameters can be normalized to a standard, so that the value of the parameters directly specifies the behaviour of the network operator service plan under consideration.

Revenue corresponds to total revenue generated by a given network operator service plan which is equal to the sum of the revenues generated by each customer in the given network operator service plan. Tendency represents affinity of mobile users towards the given service plan and is equal to a sum of the tendencies of the mobile users in the given network operator service plan. Tendency of a mobile user depends on usage w.r.t the current plan subscribed by the mobile user. In an embodiment, the usage comprises the number of local/STD/ISD calls; number of local/STD/ISD messages, number of minutes spent on local/STD/ISD calls, amount of data downloaded/uploaded using GPRS etc. Time stability represents how the network operator service plan varies over time and is equal to the number of mobile users who have joined or left a given network operator service plan. Stability metric specifies the usage behaviour of the mobile user based on the corresponding network operator service plan. For example, stability metric specifies whether most of the mobile users spend approximately a predetermined average amount or not. Stability metric may also specify whether most of the mobile users spend with wide variations or not. Age stability specifies the stability of the given service plan from the day of launch till date.

With the objective of understanding the features of instable service plan, the SPM module 106 compares the behaviour of network operator service plans. Behaviour can be in various dimensions, for example, revenue generation can be behaviour, number of customers subscribed can be another behaviour etc.). Further, the comparison of network operator service plans can be done only w.r.t each dimension of behaviour. So, to compare different network operator service plans w.r.t a particular behaviour, the SPM module 106 compares the corresponding service parameter values. For example, the SPM module 106 compares two given service plans: Plan 1 and Plan 2. To this end, the SPM module collects the Call data Records (CDR) corresponding to the respective network operator service plans. Next, the SPM module 106 calculates the one or more service parameters for the two-network operator service plans. Table 2 below shows some exemplary values of one or more service parameters for two plans: Plan 1 & Plan 2.

TABLE 2

| | | Tendency | Time | Stability | Age |
|---|---|---|---|---|---|
| | Revenue | (out of 1.0) | Stability | Metrics | stability |
| Plan 1 | 1.3 | 0.8 | . . . | . . . | . . . |
| Plan 2 | 2.1 | 0.3 | . . . | . . . | . . . |

Subsequently, the SPM module 106 compares the one or more service parameters of the two network operator service plans. It may be appreciated that Plan 1 may correspond to an instable network operator service plan and Plan 2 may correspond to the sample service plan (competitor service plan). It can be inferred from Table 2 that Plan 2 generates more revenue than Plan 1. However, Plan 1 is better at attracting mobile users than Plan 2 as tendency of Plan 1 is more than Plan 2. Hence, by comparing the one or more service parameters of the instable network operator service plan and the sample service plan, the trend in parameter values may be inferred. The SPM module 106 utilizes such inferences to stabilize the instable network operator service plan.

As described earlier, the SPM module 106 may introduce a new network operator service plan to stabilize the instable network operator service plan thereby preventing the target mobile users from churning out of the network. In an exemplary embodiment, the SPM module 106 determines the tariff rates of the new network operator service plans based on the comparison of the one or more service parameters associated with the instable network operator service plan, other network operator service plans of network operator, and the sample service plan. It may be noted that for such a new network operator service plan, no CDRs are available and hence the corresponding values of one or more service parameters need to be predicted.

In accordance with an embodiment of the invention, the SPM module 106 obtains all the available network operator service plans details and all the mobile usage data from the charging module. Next, the SPM module 106 calculates the service parameters of all the network operator service plans with required data available. The service parameters for the network operator service plans and sample service plans may be tabulated as shown below in Table 3:

TABLE 3

| | Revenue | Tendency | | Stability | Age |
|---|---|---|---|---|---|
| | (in millions) | (out of 1.0) | Time Stability | Metrics | Stability |
| Plan 1 | x1 | y1 | z1 | s1 | p1 |
| Plan 2 | x2 | y2 | z2 | s2 | p2 |
| . . . | . . . | . . . | . . . | . . . | . . . |
| Plan n | xn | yn | Zn | sn | pn |

As mentioned above, the new network operator service plan is yet to be launched in the market, and doesn't have enough CDRs. Hence, calculation of parameters is not possible. In an exemplary embodiment, the SPM module 106 predicts the service parameters for the new service plan based on the service parameters of the existing service plans. In accordance with another exemplary embodiment of the invention, the tariff rates of the new network operator service plan are pre-determined. In an embodiment, the SPM module 106 applies regression techniques on the service parameters of existing network operator service plans to obtain a regression function. Each parameter will have a unique regression function and the function can be expressed by the equations mentioned below:

x-pred=F(Rₓ₁,Rₓ₂, . . . Rₓₙ) proportional to X (call rates of the new service plan)

y-pred=F(R_{y1},R_{y2}, . . . R_{yn}) proportional to X (call rates of the new service plan)

z-pred=F(R_{z1},R_{z2}, . . . R_{zn}) proportional to X (call rates of the new service plan)

s-pred=F(Rₛ₁,Rₛ₂, . . . Rₛₙ) proportional to X (call rates of the new service plan)

p-pred=F(Rₚ₁,Rₚ₂, . . . Rₚₙ) proportional to X (call rates of the new service plan)

where,

x-pred=Predicted revenue parameter for the new service plan related to its call rates

y-pred=Predicted tendency parameter for the new service plan related to its call rates

z-pred=Predicted time stability parameter for the new service plan related to its call rates

s-pred=Predicted stability metric parameter for the new service plan related to its call rates

p-pred=Predicted age stability parameter for the new service plan related to its call rates

Rₓᵢ=Revenue details related to call rate of service plan i

R_{yi}=Tendency details related call rate of service plan i

R_{zi}=Time Stability details related call rate of service plan i

Rₛᵢ=Stability Metric details related call rate of service plan i

Rₚᵢ=Age Stability details related call rate of service plan i

In general,

Y′: Y˜X

where

Y′ corresponds to the predicted service parameter of the new service plan.

Y is a parameter.

X corresponds to call rates of a given service plan and typically multi-varied.

Hence, new network operator service plan parameters are derived by substituting the details (call rates) of the existing plan with the new service plan call rates. Table 4 below shows a sample tabular format for capturing the values of one or more service parameters for the new network operator service plan.

TABLE 4

| | | | Predicted | Predicted | |
|---|---|---|---|---|---|
| | Predicted | Predicted | Time | Stability | Predicted |
| | Revenue | Tendency | Stability | Metrics | Age Stability |
| New Plan | x-pred | y-pred | z-pred | s-pred | p-pred |

The SPM module 106 analyzes the behaviour of the new network operator service plan based on the predicted parameters. The SPM module 106 categorises all the network operator service plans (available service plans and new service plan) based on the known and predicted service parameters. Network operator Service plans in the same categories tends to show similar behaviour. If the predicted behaviour of the new network operator service plan doesn't match with the desired behaviour, i.e., doesn't show any benefit to the mobile user, then consider varying the initial pre-determined call rates and apply the service parameters again. The behaviour of the new service plan is analyzed again. The SPM module 106 repeats this process until a network operator service plan with desired behaviour (new service plan) is obtained.

The system 100 further comprises a visualization module 108 configured to generate visual representation and statistical reports representing instability of the network operator service plans based on the analysis performed by the SPM module 106. The visualization module 108 comprises dashboards, graph generators, etc. that would enable the network operator to create and view different graphical visual representations of the instability of the plurality of network operator service plans.

The system 100 further comprises an operator interface 110 configured to enable a user of the system 100 to compile the SPM module 106. The operator interface 110 also enables the user to modify one or more system parameters of the SPM module 106 during various phases of determination of the instability of the s network operator service plans. Based on one or more commands or user selections at the operator interface 110, the visualization module 108 creates graphs, pie charts, etc, collectively shown as 112 in FIG. 1. It may be appreciated that the operator interface 110 may comprise a graphical user interface (GUI) to present such graphical representations to the user.

### Exemplary Service Plan Management (SPM) Apparatus (200)

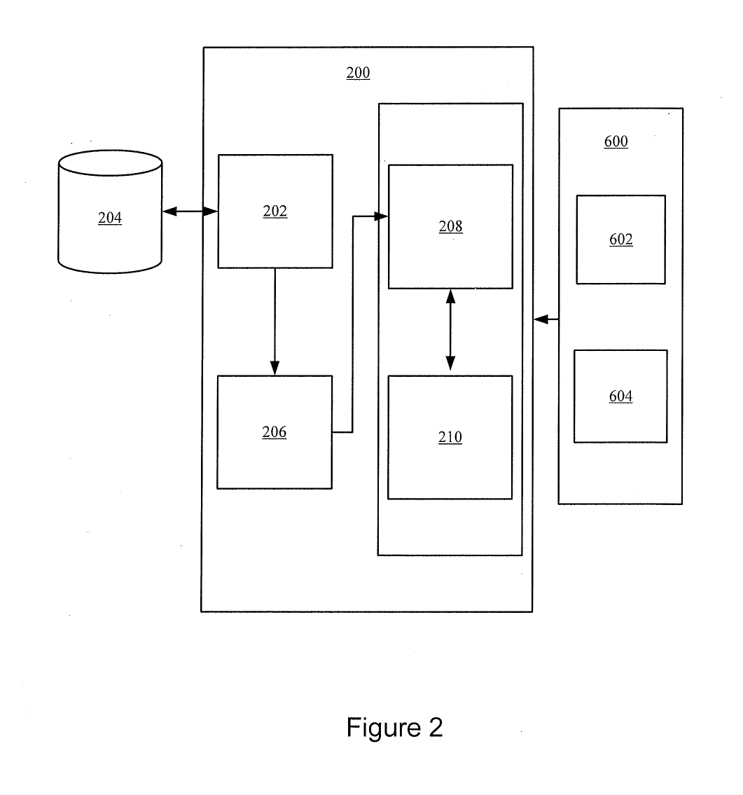

FIG. 1 has been described with specific references to a module-based approach. However, one or more modules as described above may be implemented in a multi-tier architecture for realization of a system that classifies the plurality of network operator service plans as stable/unstable. To this end, attention is drawn to FIG. 2 that illustrate an exemplary embodiment of a computing based service plan management (SPM) apparatus 200 for determining one or more instable network operator service plans in a mobile communication network. The instable service plans is determined from amongst a plurality of network operator service plans with respect to a sample service plan.

Accordingly, SPM apparatus 200 as illustrated in FIG. 2, comprises a data collection module 202 configured to collect mobile usage data from one or more data sources 204. The data collection module 202 comprises one or more data mining algorithms that access the one or more data sources 204 to collate data in a specific format suitable for easy processing. The one or more data sources 204 may comprise network operator's data sources, such as but not limited to, Call Data Record (CDR), Charging Reporting System (CRS), Service Data Point (SDP), and Interactive Voice Response (IVR), Voucher data, Device data, Customer Care data, Packet Data, etc. The one or more data sources 204 may comprise apparatus level databases; log files maintained by charging systems, knowledge data marts (KDMs), etc. The data collection module 202 may also comprise one or more routines (algorithms) that convert data files from one format to another for ease of processing and storage.

The SPM apparatus 200 further comprises a knowledge exploration and discovery module 206 configured to selectively process the mobile user data. The knowledge exploration and discovery module 206 further configured to determine a heterogeneity constant (as described above with reference to FIG. 1) for the plurality of network operator service plans based on the mobile usage data. The knowledge exploration and discovery module 206 is further configured to categorize the network operator service plans into a plurality of categories based on heterogeneity constant. Subsequently, the knowledge exploration and discovery module 206 is configured to determine the instable network operator service plans based at least in part on the determined heterogeneity constants.

The SPM apparatus 200 further comprises a visualization module 208 configured to present statistical graphs, reports, graphical representations, etc. based on the instability of the network operator service plans. As discussed earlier, the visualization module 208 assists a user in modifying one or more rules running in the data collection module 202, knowledge exploration and discovery module 206 respectively.

The SPM apparatus 200 also comprises a service delivery application program interface (API) module 210 configured to provide a subscription to the apparatus 200. In one of the embodiments, one or more components of the apparatus 200 may be owned by a third party who can then provide subscription-based access to the apparatus 200. The subscribers can be the network operators. Alternatively, the apparatus 200 may be owned by the network operator and may be installed at the network operator's site. In such a scenario, the service delivery API 210 enables the operator to monitor the complete process, modify one or more parameters, generate visual presentations, etc.

A computer program product 600 comprising of a computer readable code means 602 on which a computer program 604 is stored and where the computer program 604 when executed on a service plan management apparatus 200 causes the computing based apparatus to perform the necessary action to identify an instable network operator service plan having one or more mobile users.

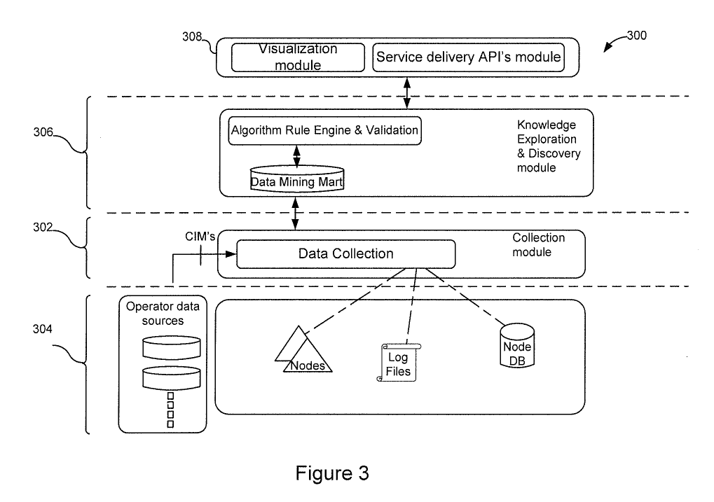

FIG. 3, illustrates a multi-tier architecture 300 of the SPM apparatus 200 in accordance with an embodiment. Accordingly, the SPM apparatus 200 may be implemented as three functional layers that may be executable in a distributed computing environment namely a first layer 302, a second layer 306 and a third layer 308. The first layer 302 can correspond to the data collection module 202 that supports collection of mobile user data from different data sources.

The first layer 302 also involves extraction, transformation, and loading of mobile usage data from the one or more data sources 304. The first layer 302 supports the flexibility to extract/process different data formats and prepares data as required by the target model or the knowledge exploration and discovery module 206. The first layer 302 also layer performs data unification, normalization and consolidation. The first layer 302 may be configured to support collection of customer data from different data sources such as customer usage; customer features & services provisioned & services used customer devices details and customer demographic data, etc. The first layer 302 may comprise of a sub-layer called Extraction, Transformation and Loading layer (not shown). The sub-layer may be configured to support the flexibility to extract/process different data formats and prepare data as required.

The second layer 306 in the multi-tier architecture may correspond to the knowledge exploration and discovery module 206. The second layer 306 supports: data mining algorithms, possibility for selection of appropriate data mining algorithms, non-availability of certain data sets or partial availability of data sets that are supported with confidence building algorithms. The third layer 308 of the architecture can corresponds to the visualization module 208 and the service delivery API module 210. The third layer 308 supports presentation of knowledge to assist domain experts to interpret information, examine, and modify the mining rules, mining algorithms that have used in the second and first layers 302, 306 respectively. As discussed earlier, service delivery APIs is published to external systems and/or users to subscribe to services and business activity monitoring capabilities provided by the SPM apparatus 200. One or more services that a user or an operator can subscribe to comprises: initiating collection, processing, order data mining activities and obtaining data mart's results externally

It is to be appreciated by those ordinarily skilled in the art that the SPM apparatus 200 may be a computing based apparatus 200 that comprises a processor configured to access and execute one or more instructions stored in a memory. The memory of such SPM apparatus 200 may also comprise one or more sub-modules that perform various functions which when aggregated would provide the functionality of the SPM apparatus 200 as described in the ongoing description. Hence, in various embodiments, the SPM apparatus 200 may be considered as a standalone computing apparatus and in other embodiments, the SPM apparatus may integrate into a system (e.g. system 100). Whether alone or integrated with a system, the scope of description with regard to the SPM apparatus 200 is not intended to be limited to these embodiments only and any other variation and combination may be implemented without departing from such scope.

### Exemplary Method

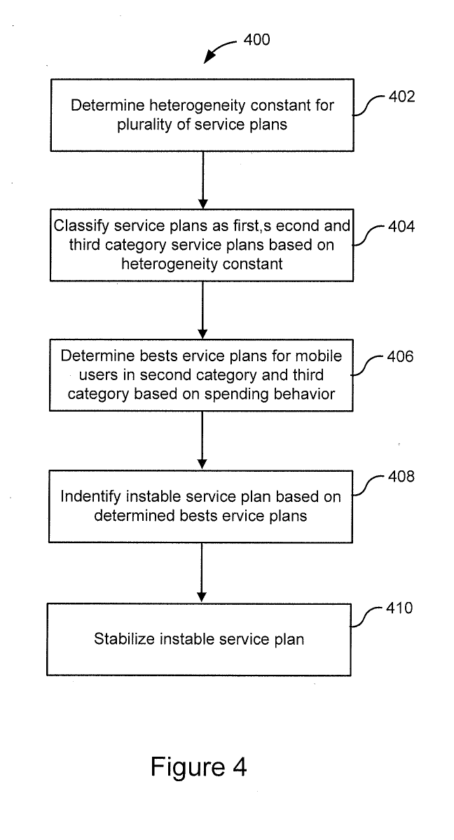

Referring now to FIG. 4, a flow chart depicting a method 400 for identifying an instable network operator service plan from a plurality of network operator service plans is shown. Each of the plurality of network operator service plans has one or more mobile users. The disclosed method prevents an outflow of the one or more mobile users from at least one network operator network operator service plan to a sample service plan.

At step 402, a heterogeneity constant for each of the plurality of network operator service plans is determined, as discussed above with reference to FIG. 1. The value of the heterogeneity constant represents the level of satisfaction/dissatisfaction of the mobile users in a given network operator service plan. The SPM module 106 calculates the heterogeneity constant for each of the plurality of network operator service plans based on mobile usage data obtained from charging module 104.

Thereafter, at step 404, based on the heterogeneity constant, the network operator service plans are classified into different categories of network operator service plans such as a stable and instable category. These categories are based on the grouping of network operator service plans with similar heterogeneity constant. In accordance with a specific embodiment of the invention, the categories are classified as first category service plans, second category service plans, and third category service plans. The first category corresponds to most satisfying service plans, the second category service plans corresponds to moderately satisfying network operator service plans, and the third category corresponds to at least satisfying service plan. In an embodiment, classifying comprises defining one or more threshold values for the heterogeneity constant. The classification is based on a comparison of the determined heterogeneity constant with the defined one or more threshold values. The network operator or a user can define the one or more threshold values.

At step 406, a best service plan is determined for each of the mobile users that are subscribed to at least one of the second category and third category service plans based at least on the spending behavior of the mobile users. The other criteria's may comprise the tariff rates of the existing network operator service plan, average usage of the mobile user, etc. The SPM module 106 determines the best service plan for mobile users subscribed to the second and the third category of service plans respectively. The best service plan is determined from amongst the plurality of network operator service plans and the sample service plan (e.g. competitor service plan). In an embodiment, the service plan for which the mobile user spends the least with the current spending behavior is defined as the best service plan for the mobile user. The best service plan determination involves obtaining spending behavior of each of the mobile users subscribed to the second and third category service plans respectively.

According to an aspect of the invention, the SPM module 106 matches a constant containing the spending behavior and the tariff rates of the mobile user in a current network operator service plan against the other available network operator service plans and the competitors network operator service plan. Further, the SPM module 106 calculates the spending of the mobile user in each of the network operator service plans and the competitor's network operator service plan on the basis of the average usage by the mobile user and tariff rates of the existing network operator service plan. Further, the SPM module 106 computes the most optimum/cheaper network operator service plan available for the mobile user by selecting a best network operator service plan that best suits the mobile users requirements and spending behavior.

In accordance with a further embodiment of the invention, the determination of best network operator service plan comprises associating the mobile users subscribed to the second and third category service plan to every other network operator service plan in the plurality of network operator service plans keeping the spending behavior constant. In such a determination, the determination of best service plan also comprises calculating the spending in each of the network operator service plan based on the association. In another embodiment, the best service plan is determined based on a payoff matrix between the mobile users and the network operator. The best plan, in one of the embodiments, may correspond to at least spending of the mobile users and maximum revenue for the network operator.

At step 408, the instable network operator service plan is determined from amongst the plurality of network operator service plans based on the best service plan determination. The instable network operator service plan is the one in which maximum number of mobile users correspond to sample service plan as the corresponding best network operator service plan. The SPM module 106 determines the instable network operator service plan based on the network operator service plan determination as above.

Subsequently, at step 410, the instable network operator service plan is stabilized based on the identification. The SPM module 106 provides for options to stabilize the instable network operator service plan. This may be implemented by invoking the visualization module 108 to display graphical representations of instabilities across different network operator service plans. The operator interface 110 can enable a user of the system to interact and/or modify one or more rules for the visualization module 108 and the service plan management module 106.

In accordance with another embodiment of the invention, the stabilizing comprises modifying tariff rates associated with the instable network operator service plan, modifying tariff rates associated with one or more of the plurality of network operator service plans other than the instable network operator service plan. In yet another embodiment, the stabilizing comprises proposing a new network operator service plan substantially similar to the sample service plan. In an embodiment, the stabilizing may further comprise computing one or more service parameters of the instable network operator service plan, the sample service plan, and one or more of the plurality of network operator service plans. In such an embodiment, the stabilizing comprises comparing the one or more service parameters of the instable network operator service plan with the sample service plan and/or the one or more of the plurality of network operator service plans. The stabilization of instable network operator service plan corresponds to a corrective action that may be taken to prevent the outflow of mobile users from the instable network operator service plan to the sample service plan.

In accordance with another embodiment of the invention, prior to and subsequent to the association of the mobile users to the best service plan, a net heterogeneity constant of the plurality of network operator service plans may be calculated (as discussed above with reference to FIG. 1). The net heterogeneity constant may enable the network operator to determine the overall stability of the association of plurality of the network operator service plans and the mobile users.

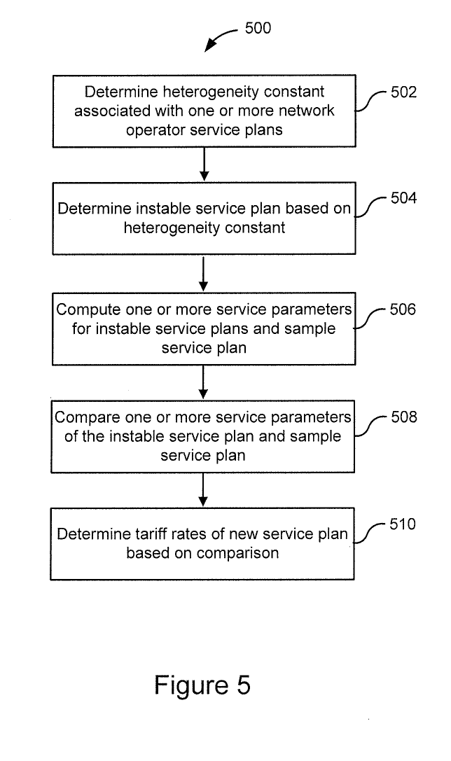

Referring now to FIG. 5, a flow chart illustrating an exemplary method 500 for determining tariff rates of a new network operator service plan is shown, in accordance with an embodiment of the invention. At step 502, heterogeneity constant associated with one or more network operator service plans is determined based on the mobile usage data of a plurality of mobile users that are subscribed to the one or more network operator service plans. The SPM module 106 determines the heterogeneity constant for each network operator service plan of network operator.

At step 504, based on the determined heterogeneity constants in step 502, an instable network operator service plan is determined. The SPM module 106 determines the instable network operator service plan with respect to a sample service plan.

At step 506, one or more service parameters corresponding to the one or more network operator service plans and sample plan are computed. Examples of the service parameters comprise, but are not limited to, revenue defining the total revenue generated by the network operator service plan, usage tendency of the mobile users towards the network operator service plan, stability of the network operator service plan over the time, stability metrics specifying the usage behavior of the mobile users, and stability of the network operator service plan from the day of launch till date. The SPM module 106 computes the one or more service parameters for the one or more network operator service plans and the sample service plan.

Thereafter, at step 508, the one or more service parameters of the instable network operator service plan are compared with the one or more service parameters of the sample service plan. To compare the service parameters, the call data records (CDRs) of the mobile users for the corresponding network operator service plans are collected and the service parameters are calculated based on the collected CDRs. The SPM module 106 compares the one or more service parameters for the instable network operator service plans and the sample service plan.

At step 510, based on the comparison performed in step 508, the tariff rates of a new network operator service plan is determined. In an embodiment, determining the tariff rates comprises determining the one or more service parameters for the new network operator service plan based at least on the one or more service parameters of the instable network operator service plan and/or the sample service plan. The determining may also comprise predicting the one or more service parameters for the new network operator service plan based on a regression technique. The SPM module 106 determines tariff rates of the new network operator service plan to be launched by the network operator.

In accordance with an embodiment of the invention, a computer program product 600 is disclosed. The computer program product 600 comprises a computer readable code means 602 on which a computer program 604 is stored and where the computer program 604 when executed on a computing apparatus. In an embodiment, the computing apparatus corresponds to the SPM apparatus 200. The computer program when executed causes the computing apparatus to access one or more data sources and obtain mobile usage data associated with a plurality of mobile users subscribed to a plurality of network operator service plans. The computer program when executed further causes the computing module to compute a heterogeneity constant for each of the plurality of network operator service plans and a net heterogeneity constant for the plurality of network operator service plans. The computer program further causes the computing module to identify an instable network operator service plan based at least in part on the heterogeneity constant, the net heterogeneity constant and spending habit of the plurality of mobile users. Subsequently, the computer program when executed causes the computing apparatus to provide selectable options to stabilize the instable network operator service plan. Such selectable options may be presented to a user or network operator for suitable selection of options.

The disclosed system and method have the advantage of precisely finding the instability of the existing network operator service plans for all mobile users in the network. Further, the SPM module 106 defines a new measure, which indicates the instability of the network operator service plans of the network operator. The disclose systems also determine a specific payoff if the mobile users are put in another newly proposed plan in comparison to their current plan. This helps the network operator in identifying best network operator service plans for the mobile user in its own network. Payoff matrix approach implemented by the disclosed method and system enable mutual benefit (economic) for both the mobile users and the network operators. The disclosed system further enables the network operators to understand the features of instable network operator service plans by calculating various service parameters. Therefore, the disclosed system not only quantifies the instability of a given network operator service plan with respect to other network operator service plan but also provides for qualitative analysis of a given instable network operator service plan with respect to more stable network operator service plans. Furthermore, the disclosed system enables the network operator to propose a new network operator service plan with modified features, which are suitable for the benefit of both mobile users and network operator.

It will be appreciated that the teachings of the invention, disclosed system, and method can be implemented as a combination of hardware and software. The software is preferably implemented as an application program comprising a set of program instructions tangibly embodied in a computer readable medium. The application program is capable of being read and executed by hardware such as a computer or processor of suitable architecture. Similarly, it will be appreciated by those skilled in the art that any examples, flowcharts, functional block diagrams and the like represent various exemplary functions, which may be substantially embodied in a computer readable medium executable by a computer or processor, whether or not such computer or processor is explicitly shown. The processor can be a Digital Signal Processor (DSP) or any other processor used conventionally that is capable of executing the application program or data stored on the computer-readable medium.

The example computer-readable medium can be, but is not limited to, (Random Access Memory) RAM, (Read Only Memory) ROM, (Compact Disk) CD or any magnetic or optical storage disk capable of carrying application program executable by a machine of suitable architecture. It is to be appreciated that computer readable media also comprises any form of wired or wireless transmission. Further, in another embodiment, the method in accordance with the present invention can be incorporated on a hardware medium using ASIC or FPGA technologies.

Aspects of the invention may also be implemented in methods and/or computer program products. Accordingly, the invention may be embodied in hardware and/or in hardware/software (including firmware, resident software, microcode, etc.). Furthermore, the invention may take the form of a computer program product on a computer-usable or computer-readable storage medium having computer-usable or computer-readable program code embodied in the medium for use by or in connection with an instruction execution system. The actual software code or specialized control hardware used to implement embodiments described herein is not limiting of the invention. Thus, the operation and behavior of the aspects were described without reference to the specific software code—it being understood that one would be able to design software and control hardware to implement the aspects based on the description herein.

Furthermore, certain portions of the invention may be implemented as “logic” that performs one or more functions. This logic may comprise hardware, such as an application specific integrated circuit or field programmable gate array or a combination of hardware and software.

It is to be appreciated that the subject matter of the claims are not limited to the various examples an language used to recite the principle of the invention, and variants can be contemplated for implementing the claims without deviating from the scope. Rather, the embodiments of the invention encompass both structural and functional equivalents thereof.

While certain present preferred embodiments of the invention and certain present preferred methods of practicing the same have been illustrated and described herein, it is to be distinctly understood that the invention is not limited thereto but may be otherwise variously embodied and practiced within the scope of the following claims.

1. A method for identifying an instable network operator service plan from a plurality of network operator service plans, each of the plurality of network operator service plans having one or more mobile users, the method being performed by a computer and comprising the steps of:
determining a heterogeneity constant for each of the plurality of network operator service plans, the heterogeneity constant being representative of an instability of each of the plurality of network operator service plans;
based at least in part on the heterogeneity constant, classifying the network operator service plans among different categories of network operator service plans, wherein at least one category identifies an instable network operator service plan;
for each of the mobile users subscribed to at least one of the instable network operator service plan category, determining a best network operator service plan from amongst the plurality of network operator service plans and a sample network operator service plan based at least in part on a spending behavior of the respective ones of the mobile users; and
identifying, the instable network operator service plan from amongst the plurality of network operator service plans in which maximum number of mobile users correspond to the sample network operator service plan as the correspondingly determined best network operator service plan.

2. The method according to claim 1 further comprising stabilizing the instable network operator service plan based at least in part on the identifying.

3. The method according to claim 1, wherein the classifying comprises defining one or more threshold values for the heterogeneity constant.

4. The method according to claim 3, wherein the classifying comprises comparing the determined heterogeneity constant with the one or more threshold values.

5. The method according to claim 1, wherein determining the best network operator service plan comprises obtaining spending behavior of each of the mobile users subscribed to at least one of the instable network operator service plan category respectively.

6. The method according to claim 1, wherein determining the best network operator service plan comprises associating the mobile users subscribed to at least one of the instable network operator service plan category to every other network operator service plan in the plurality of network operator service plans keeping the respective spending behavior constant.

7. The method according to claim 6, wherein determining the best network operator service plan comprises calculating the spending in each of the network operator service plan based on the association.

8. The method according to claim 1, wherein determining the best network operator service plan comprises determining a payoff matrix between the mobile users and a network operator when the best network operator service plan corresponds to one of the plurality of network operator service plans offered by the network operator and the sample network operator service plan.

9. The method according to claim 6, identifying the instable network operator service plan further comprises calculating a net heterogeneity constant of the plurality of network operator service plans prior to and subsequent to the associating of the plurality of mobile users.

10. The method according to claim 1, wherein the best network operator service plan corresponds to at least spending by the mobile users.

11. The method according to claim 1, wherein the best network operator service plan corresponds to at least spending by the mobile users and a maximum revenue for a network operator with respect to a given network operator service plan.

12. The method according to claim 2, wherein the stabilizing comprises modifying tariff rates associated with the instable network operator service plan.

13. The method according to claim 2, wherein the stabilizing comprises modifying tariff rates associated with one or more of the plurality of network operator service plans other than the instable network operator service plan.

14. The method according to claim 2, wherein the stabilizing comprises proposing a new network operator service plan substantially similar to the sample network operator service plan.

15. The method according to claim 2, wherein the stabilizing comprises computing one or more service parameters of the instable network operator service plan, the sample network operator service plan, and one or more of the plurality of network operator service plans.

16. The method according to claim 15, wherein the one or more service parameters corresponds to one or more of revenue, tendency, time stability, stability metric, and age stability associated with the instable network operator service plan, the sample network operator service plan, and one or more of the plurality of network operator service plans.

17. The method according to claim 15, wherein the stabilizing comprises comparing the one or more service parameters of the instable network operator service plan with the sample network operator service plan and/or the one or more of the plurality of network operator service plans.

18. A system for determining an instable network operator service plan from amongst a plurality of network operator service plans with respect to a sample service plan, the system comprising:
a charging module configured to provide mobile usage data associated with a plurality of mobile users, each of the plurality of mobile users subscribed to one of the plurality of network operator service plans;
a service plan management module configured to:
compute a heterogeneity constant for each of the plurality of network operator service plans based on the mobile usage data; and
determine the instable network operator service plan based at least in part on the computed heterogeneity constant.

19. The system according to claim 18 further comprising a visualization module configured to generate visual representation and statistical reports representing instability of the plurality of network operator service plans.

20. The system according to claim 18, wherein the service plan management module is further configured to, classify the network operator service plans among different categories of network operator service plans, wherein at least one category identifies an instable network operator service plan based at least in part on the heterogeneity constant.

21. The system according to claim 18, wherein the service plan management module is further configured to, for each of the mobile users subscribed to at least one of the instable network operator service plan category, determine a best network operator service plan from amongst the plurality of network operator service plans and a sample network operator service plan based at least in part on the spending behavior of the mobile users.

22. The system according to claim 21, wherein the instable network operator service plan corresponds to one of the network operator service plan in which maximum number of mobile users correspond to the sample network operator service plan as the determined best network operator service plan.

23. The system according to claim 18, wherein the service plan management module is further configured to stabilize the instable network operator service plan.

24. The system according to claim 18, wherein the service plan management module is further configured to compute a net heterogeneity constant of the plurality of network operator service plans, the net heterogeneity constant being indicative of the stability of the system in relation to the association of the plurality of mobile users and corresponding network operator service plans.

25. A service plan management apparatus for determining one or more instable network operator service plans from amongst a plurality of network operator service plans with respect to a sample network operator service plan, the service plan management apparatus comprising:
a data collection module configured to collect mobile user data from one or more data sources, the mobile user data associated with a plurality of mobile users subscribed to the plurality of network operator service plans; and
a knowledge exploration and discovery module configured to:
selectively process the mobile user data and determine heterogeneity constant for the plurality of network operator service plans based on the mobile user data; and
determine the one or more instable network operator service plans based at least in part on the heterogeneity constants.

26. The service plan management apparatus according to claim 25 further comprising a visualization module configured to:
present statistical graphs, reports, graphical representations based on instability of network operator service plans, and
assist experts in modifying one or more rules corresponding to data collection, knowledge exploration, and discovery respectively.

27. The service plan management apparatus according to claim 25 further comprising a service delivery application program interface module configured to provide a subscription to the service plan management apparatus.

28. The service plan management apparatus according to claim 25, wherein the one or more data sources comprises one or more of Call Data Record, Charging Reporting System, Service Data Point, Interactive Voice Response, Voucher data, Device data, Customer Care data, Packet data, etc.

29. A computer program product comprising a computer readable code means on which a computer program is stored and where the computer program when executed on a service plan management apparatus causes the service plan management apparatus to:
access one or more data sources and obtain mobile usage data of all the mobile users subscribed to their respective network operator service plans;
compute a heterogeneity constant for each of the plurality of network operator service plans and a net heterogeneity constant for the plurality of network operator service plans based on the mobile usage data;
identify an instable network operator service plan based at least in part on the heterogeneity constant and spending habit of the plurality of mobile users; and
provide selectable options to stabilize the instable network operator service plan.
